(19) United States
(12) Patent Application Publication
(10) Pub. No.: US 2007/0084016 A1
(43) Pub. Date: Apr. 19, 2007

(54) Hinge assembly

(76) Inventors: Cord Bommelmann, Rahden (DE); Matthias Hallik, Wiesbaden (DE); Jens Schenkenberger, Frankfurt (DE); Patrick Verhee, Frankfurt (DE)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 10/559,593

(22) PCT Filed: Feb. 20, 2004
(86) PCT No.: PCT/DE04/00322

§ 371 Date: Nov. 16, 2006

(30) Foreign Application Priority Data
Jun. 4, 2003 (DE) 103 25 232.0

(51) Int. Cl. E05D 3/06

(52) U.S. Cl. 16/366

(57) ABSTRACT

Disclosed is a hinge device (2, 22) comprising a lever (6) that is provided with two top parts (4, 5). Said two top parts (4, 5) are used for assembling the lever (6) and are pivotable about one respective pin located at the ends of the lever (6). Two traction ropes (8, 9) are provided which grip the two top parts (4, 5) at gripping points (12, 13, 16, 17) located on different sides of a plane that is defined by the two pins.

The invention relates to a hinge device comprising a lever that is provided with two top parts, which are used for assembling the lever to a door or hood or a frame and are pivotable about pins located at the ends of the lever, respectively. The invention relates particularly to a hinge device for a rotatable and pivotable door that can pivot open in a parallel fashion, a pantograph-type door.

Doors of this type can be found increasingly in buses today. The reason is that in the case of a rotatable and pivotable door, an entire door opening cross-section is exposed in a lateral wall of the bus when pivoting the door similar to a sliding door. Unlike conventional doors, this allows fragile and disabled persons to enter and exit more easily and is particularly advantageous for tight parking spaces.

It is known to implement pantograph-type doors that swing open and comprise a hinge device parallel to the side wall of the vehicle, the device comprising levers pivotable about different axes. It is known that at least two levers are required, of which one lever, referred to as a load lever, acts as a positioning element and one lever, referred to as a control lever, acts as an orientating element. The disadvantage with a hinge device of this type comprising several levers is an increased need for space due to the plurality of lever connections to the door and frame. The levers are typically disposed in the entrance region and particularly interfere there close to the ground. Furthermore, it is disadvantageous that in the event of an accident the levers may bend, resulting in jamming, which impairs the opening of the door in case of an emergency and/or makes it impossible.

It is the object of the present invention to create a hinge device for a rotatable and pivotable door or a hood, which requires only a small number of levers and prevents the above disadvantages.

According to the invention, this object is achieved with a hinge device with the characteristics according to claim 1.

The lever of the hinge device according to the invention corresponds to the load lever of the known pantograph-type doors, while the traction ropes assume the function of the control lever. The traction ropes may even be disposed adjacent or in close proximity to the lever or even in the hollow interior thereof, so that no additional space is required and the hinge device overall requires less space than conventional hinge devices. Furthermore, when configuring the invention with traction ropes that are able to change their shape, such as chains or V-belts, jamming in the event of an accident resulting in bending of the lever is nearly entirely avoided, making a vehicle with a door comprising a hinge device according to the invention significantly safer than vehicles with doors comprising conventional hinge devices.

In a preferred embodiment of the invention, the bodies are rotationally coupled to the respectively associated top part at the same gear ratio, wherein the gripping points have the same distance from the plane. At least one of the top parts may be coupled to a body around which the connected traction ropes are wrapped. The body may be connected in force-fit manner to the top part of the respective end, so that a shift of the traction ropes drives a rotation of the top part. In such a case, preferably at least one of the traction ropes comes tangentially in contact with a wrapped surface of the body. This can be achieved in that the body is configured as a circular disk. When the gripping points have the same distance from the plane and when disk-shaped bodies are provided on the two ends of the lever, this means for disk-shaped bodies that the bodies have identical diameters.

Upon actuation of the hinge device, while pivoting the lever, the gripping points in this embodiment of the invention migrate along a surface of the body since the surface of the body around which the traction ropes are wrapped changes when pivoting the lever. However, in no position of the levers can the gripping points change the side of the plane. The traction ropes transmit a rotational movement of a top part across the lever to the other top part, so that a rotatable and pivotable door with a hinge device of this type can swing open parallel.

The circumferential regions of a circular disk of this type, which regions during the pivoting motion of the lever never come in contact with the traction ropes, can be eliminated, so that also a circular sector shape becomes possible for the wrapped body.

The body may be, for example, a gear wheel, the teeth of which mesh with the traction ropes. The traction ropes advantageously are chains, the chain links of which have meshing areas for the teeth of the gear wheel, or they are V-belts or chains with chain members, which in turn have teeth so that the teeth of the belts or chains mesh with the teeth of the gear wheel.

It is preferred if the pin of the top part coincides with the axis of rotation of the respectively associated body. In this case it will be possible to configure the body with the associated top part as a rigid unit.

It is also possible to connect the traction ropes continuously to an endless loop.

In another embodiment, the body is connected to the respective top part via a gear set, for example a planetary gear arrangement, or a different gear wheel configuration. The gear set may have different gear ratios between the body and the top part. The greater the gear ratio, the faster the endless loop of the traction ropes revolves during a pivoting motion, and the lower the forces transmitted in the process, meaning the lower the internal stress of the lever, which occurs when an external counter-force counteracts a pivoting motion. This reduced internal stress allows a lightweight and consequently cost-efficient design of the lever.

In a particularly preferred embodiment, the lever is bent in at least one angle. The lever particularly has an L-shaped design. Rotatable and pivotable doors with a hinge device of this type thus achieve a greater door opening angle since the lever rests against an exterior side wall surrounding the door opening with an angled section when the door is swung open and thus also the door is moved closely to the side wall. In a configuration of the lever of this type, deflection elements for the traction ropes, preferably in the form of deflection rollers, are suitably provided on the angle.

So as to keep the projection of the bent lever into the interior of the vehicle to a minimum, the traction ropes in the section of the lever articulated on the door are preferably configured such that they extend toward each other, preferably from the top part to the angle.

So as to prevent excess curvature of a traction rope on the deflection elements, particularly of the rope extending along the convex side of the lever, two deflection elements may be provided on the traction rope.

In a further preferred embodiment of the invention, the lever has a hollow configuration, and the traction ropes and the wrapped bodies are accommodated therein. This way, movable parts are covered and protected. In another advantageous effect of this embodiment, the lever may even assume additional functions in that it can be used, for example, as an arm rest surface.

A motor, preferably an electric motor, for a servo drive of the hinge device may be attached to the lever for driving the top parts.

In a first embodiment, this motor is provided with a pinion combing with one of the traction ropes. When the bodies coupled to the top parts are gear wheels around which the traction ropes are wrapped, the pinion of the motor may also engage on one of these gear wheels. A motor of this type is preferably disposed on the inside of the hollow lever.

It is possible to configure a combined hinge device, wherein a plurality of hinge devices according to the invention are mutually connected. A combined hinge device of this type is advantageous for high doors, for example, where the hinge devices according to the invention are disposed at different heights. A combined hinge device of this type is particularly robust.

On a door comprising several hinge devices according to the invention and/or the combined hinge device, the levers are mounted to the door with a first top part and are disposed staggered in such a manner that the first and second axes coincide.

When the door comprising the hinge device according to the invention is part of a motor vehicle, the levers are mounted to a frame of this motor vehicle with a second top part. The door may advantageously be a fold-up swing door with substantially horizontal swivel axes, but also a door with vertical swivel axes, such as those found on a bus.

The hinge device according to the invention may also be used on hoods, for example on engine compartment hoods or trunk hoods of a motor vehicle so as to provide them with the option of being swung open in a parallel fashion.

The invention will be explained in more detail hereinafter based on two preferred embodiments with reference to the figures, wherein:

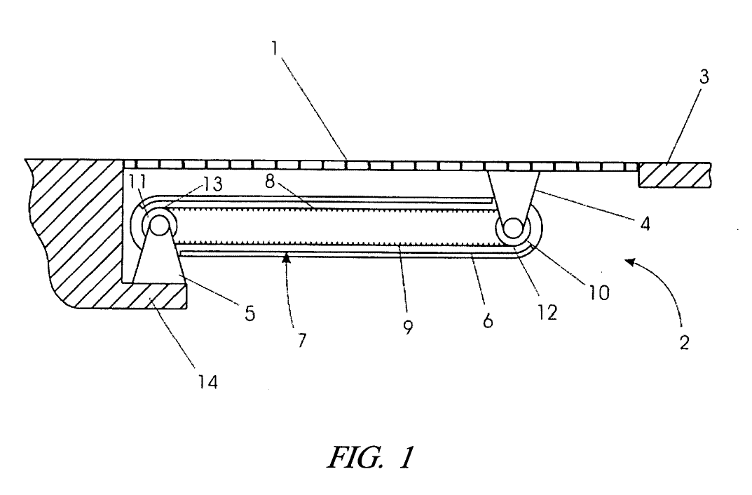

FIG. 1 is a door with a hinge device according to the invention in the closed state;

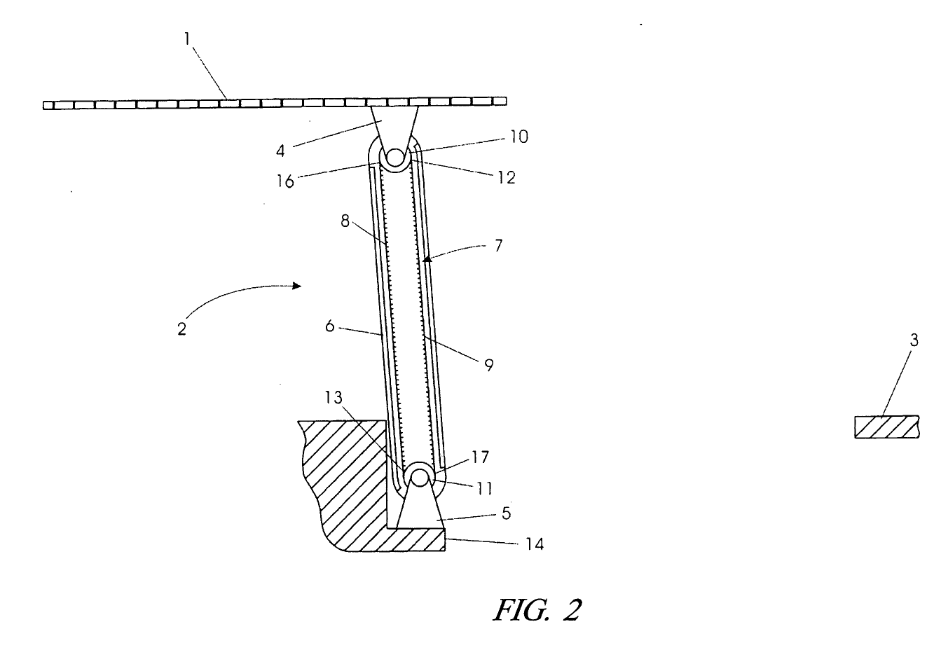

FIG. 2 is the door according to FIG. 1 in the open state;

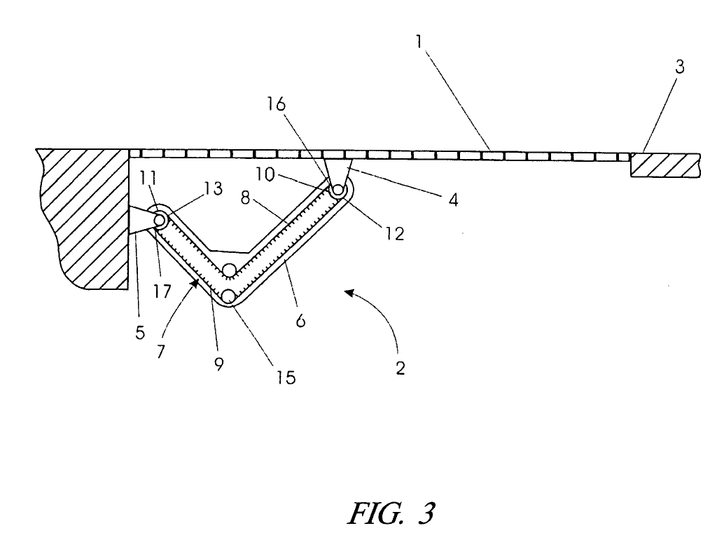

FIG. 3 is a door with an alternatively configured hinge device according to the invention in the closed state;

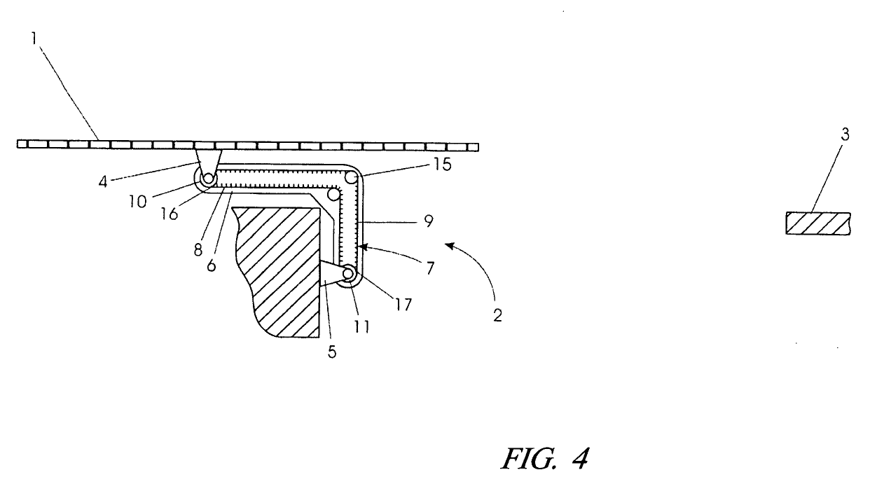

FIG. 4 is the door according to FIG. 3 in the open state;

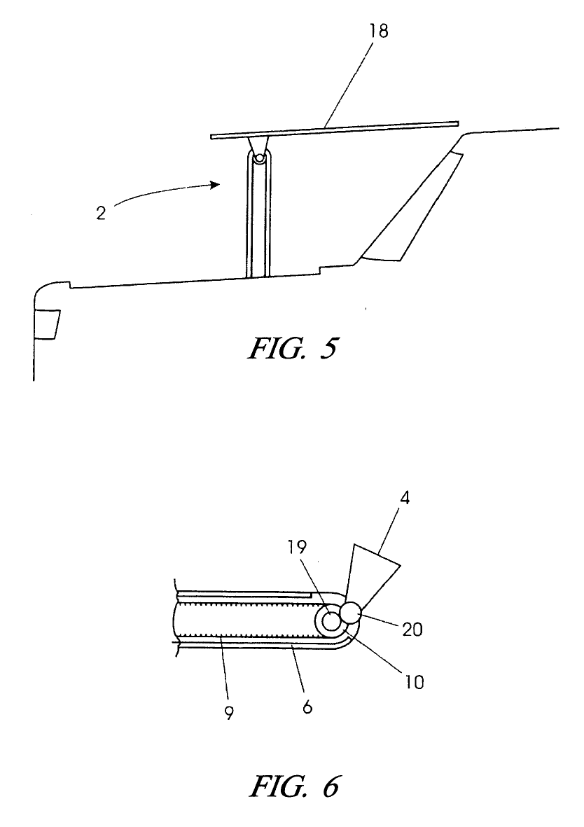

FIG. 5 is an inside view of a door with a hinge device according to the invention;

FIG. 6 is a horizontal sectional view through the door and the hinge device according to FIG. 5;

FIG. 6a is a sectional view analog to FIG. 6 through a modified embodiment of the hinge device;

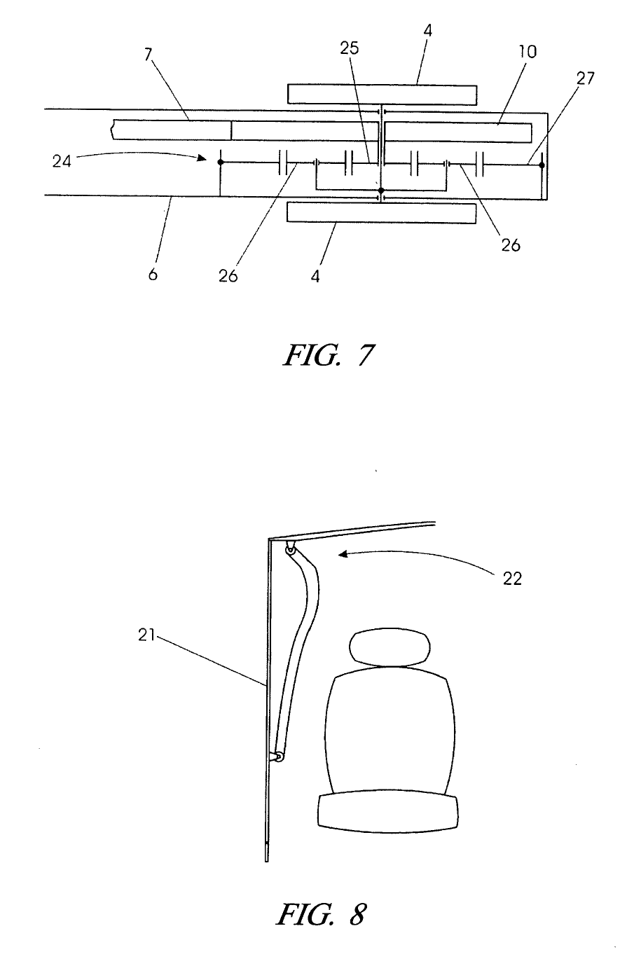

FIG. 7 is a sectional view analog to FIG. 6 through a first variation of a motorized hinge device;

FIG. 8 is a sectional view through the lever according to FIG. 7 along the line marked with VIII;

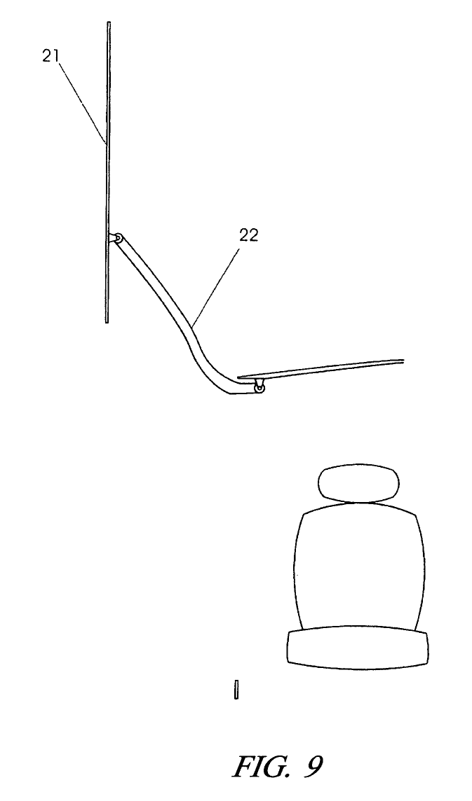

FIG. 9 is a sectional view analog to FIG. 6 through a second variation of a motorized hinge device;

FIG. 10 is a sectional view through the hinge device according to FIG. 9 along the line IX;

FIG. 11 is an engine hood with a hinge device according to FIG. 1 in the open state;

FIG. 12 is an end section of the lever with a gear set;

FIG. 13 is an end section of the lever with a planetary gear set;

FIG. 14 is a motor vehicle with a door pivoting open upward; and

FIG. 15 is the motor vehicle according to FIG. 14 with an open door.

A door 1 for a motor vehicle comprising a hinge device 2 according to the invention is shown in FIG. 1 in a sectional view in the closed state. The door 1 in this state ends flush with a side wall 3 of the motor vehicle. The hinge device 2 comprises a hollow lever 6, which for the sake of simplicity is illustrated with the cover removed, two top parts 4 and 5, which are disposed at the ends of the lever 6 and are pivotable about an axis vertical to the plane of the figure, as well as a chain or a toothed belt 7 in the form of an endless loop, which is disposed inside the lever 6. So as to allow the top parts 4, 5 to pivot, a side wall of the hollow lever 6 comprises passages at the ends thereof. A circular disk 10 is non-rotatably connected to the top part 4, and a circular disk 11 is non-rotatably connected to the top part 5. Both disks 10, 11 are disposed inside the hollow lever 6. The disk 10 is centered on the swivel axis of the top part 4 and the disk 11 is centered on the swivel axis of the top part 5. The toothed belt 7, the teeth of which mesh with complementary recesses of the disks 10, are wrapped around the disks 10 and 11, thus establishing a connection between the disks 10 and 11 and consequently between the top parts 4 and 5. The top part 4 is attached to the door 1 and firmly connected thereto, while the top part 5 is attached to an inner recess 14 of the side wall 3 with the orientation being opposite to the top part 4. The lever 6 as well as a plane extending through the axes of the top parts 4 and 5 are oriented parallel to the door 1. In this orientation, a gripping point 12 is created for the toothed belt 7, on which point the toothed belt 7 grips a side of the disk 10 facing away from the door 1, as well as a gripping point 13, on which the toothed belt 7 grips the side of the disk 11 facing the door 1. Gripping points of the toothed belt 7 complementing the gripping points 12 and 13 are covered in the illustration by the top parts 4 and 5. The gripping point 12 as well as the hidden complementary gripping point thereto are located on different sides of the plane extending through the axes of the top parts 4 and 5. The same applies to the gripping point 13 and the complementing, hidden gripping point thereto. Since the diameters of the disks 10, 11 are identical, the distance of all gripping points from this plane is the same.

FIG. 2 shows the door according to FIG. 1 in the open state. During the pivoting movement from the position shown in FIG. 1 into the position shown in FIG. 2, the top parts 4 and 5 are pivoted about their respective axes at the ends of the lever 6. Due to the rigid configuration of the disks 10 and 11 with the respective top parts 4 and 5, the toothed belt 7 revolves around the disks 10 and 11 during the pivoting movement. As a result, the traction rope 8 of the toothed belt 7 travels towards the top part 4 and the traction rope 9 travels towards the top part 5. Due to this movement, also the gripping points 12 and 13 shift along the disks 10 and 11, so that they assume the new positions shown in FIG. 2 on the disks 10 and 11.

Also the gripping points 16 and 17 complementing the gripping points 12 and 14 change their positions on the disks 10 and 11, so that they are visible in the positions shown in FIG. 2. The gripping point 12 and the gripping point 17 are located on one side of this plane, while the gripping points 13 and 16 are disposed on the opposite side. Due to the operation of the toothed belt 7, torque is applied on the disk 10 about the pin of the top part 4. Due to the rigid configuration of the disk 10 with the top part 4 and the assembly of the top part 4 to the door 1, this torque is passed on to the door 1, so that the door 1 during the entire pivoting movement as well as in the open state according to FIG. 2 maintains the parallel orientation to the side wall 3.

An alternative embodiment of the hinge device 2 with an angled lever 6 is shown in FIG. 3.

In this embodiment, the lever 6 is L-shaped. Unlike the embodiment described above, the orientation of the top part 5 is perpendicular to the orientation of the top part 4. The top part 5 is mounted to a surface of the side wall 3, which surface is perpendicular to the door 1. At the angle of the lever 6, deflection rollers 15 are provided, around which the traction ropes 8 and 9 of the toothed belt 7 are guided. This ensures parallel movement of the toothed belt 7 to the lever 6, which makes it possible to accommodate the toothed belt on the inside of the hollow lever 6. Again, the gripping points 12, 16 and 13, 17 of the traction ropes 9 and 6 are disposed on the disks 10 and 11 on different sides of the planes extending through the axes of the top parts 4 and 5.

FIG. 4 shows the door 1 with the hinge device 2 according to FIG. 3 with the angled lever 6 in the open state. The operating principle of this hinge device 2 during the pivoting movement of the lever 6 corresponds to that of the hinge device 2 described with reference to FIGS. 1 and 2 and will not be addressed again here. FIG. 4, however, shows the particular advantage of the angled lever 6, as a result of which the door 1 in the open state rests more closely to the side wall 3 and thus exposes the entire door opening cross-section in the side wall 3.

The toothed belt 7 can easily be replaced with a suitable chain, such as a toothed chain or a roller chain, wherein teeth of the disks 10, 11, which are then configured as gear wheels, can mesh with the spaces between the links.

FIG. 5 shows an application of the hinge device 2 according to the invention as a suspension for a rear door 1 of the passenger compartment of a motor vehicle. In the lower region, the door 1 comprises a basically known door body made of a metal sheet located on the outside, which is not visible in the Figure, and interior molding 28, which is oriented towards the passenger compartment. The interior molding has a wide horizontal groove 29, extending from the edge of the door 1 adjoining the C-column to just before the B-column 30. The lever 6 is lowered substantially into the groove 29, one top part 4 is firmly connected to the door 1, and the other top part 5 is connected to the C-column. The purpose of lowering the lever 6 in the groove 29 is to minimize the projection of the lever into the passenger compartment to the extent possible, which would limit the lateral space available to passengers in the back.

As FIGS. 3 and 4 have shown, a bent shape of the lever 6 is desirable in order to achieve maximum freedom of motion of the door.

However, as is clearly evident according to FIG. 3, a lever that is bent too much would protrude far into the interior of the vehicle, which would interfere with the seats located directly adjacent to the door 1, particularly in the case of a passenger car.

As is apparent from the sectional view according to FIG. 6, the embodiment according to FIGS. 5, 6 prevents the lever 6 from protruding too far into the passenger compartment due to the integration of the deflection rollers 15 around which the toothed belt 7 of the lever 6 is wrapped.

While in the embodiment according to FIG. 4, the two ropes 8, 9 of the toothed belt 7 are guided parallel on either side of the deflection rollers 15, in the embodiment according to FIG. 6 the deflection rollers 15 are positioned such that, viewed from the pulley 10, the ropes 8, 9 extend towards each other in the longer section of the lever 6 resting against the door 1, so that the rope 9 does not protrude as far into the vehicle interior when the door is closed as would be the case with the parallel rope guidance shown in FIG. 4. The housing of the lever 6 can have an accordingly uninviting shape.

Since the rope 8 with the non-toothed surface rests against the deflection roller 15, it can have greater curvature there than the rope 9 on which the teeth face the deflection roller 15 and may come in contact with each other in the event of too great a curvature. So as to prevent this, two deflection rollers 15 are provided for deflecting the rope 9.

If the distance of the teeth on the toothed belt 7 is sufficient to allow greater curvature of the rope 9, or if the toothed belt has been replaced with a strongly curved link chain, such as a plate link chain, the lever 6 can be designed to protrude even less into the interior of the vehicle, which is shown according to FIG. 6a. The flank of the lever 6 facing the door in the closed state has the same shape as that according to FIG. 6. However, the two deflection rollers 15 have been shifted into the short section of the lever 6, in which the chassis-mounted pulley 11 is located. This, as well as the fact that the two ropes 8, 9 extend toward each other starting from the pulley 10 to the bend of the lever 6, allow the lever to be provided with a concave shape at the height of the bend and further reduce the projection into the vehicle interior when the door is closed.

The lever shown in FIG. 7 corresponds in its dimensions and the configuration of the pulleys 10, 11 and deflection rollers 15 to the lever shown in FIG. 6. The lever according to FIG. 7 differs from that according to FIG. 6 by an electric motor 31, which is disposed on the inside of the lever 6 adjacent to the pulley 10 between two ropes 8, 9 of the toothed belt 7.

The electric motor 31 has a first pinion 32 on the shaft, which pinion meshes with the teeth of the pulley 11 via an intermediate pinion 33.

A first switch 34 for starting up the motor is provided on a side wall of the housing of the lever 6, which in the closed state of the door shown in the Figure faces the interior of the passenger compartment and is easily accessible for a passenger.

By actuating this switch 34, the motor is prompted to rotate the pinion 32 clockwise, as a result of which the arm pivots counterclockwise around the pulley 11 and the door opens. As is obvious from FIG. 6, in the open state of the door the switch 34 is not accessible, so that a second switch 35 is provided in a location of the housing of the lever adjacent to the pulley 11 for starting up the motor in the opposite direction, which switch is also accessible when the door is open.

In the modified embodiment according to FIGS. 9 and 10, the electric motor 31 is provided in the vicinity of the pulley 11 and the pinion 32 attached to the shaft combs with a second pinion 33, which is mounted on a common axis with a deflection roller deflecting the rope 9. Contrary to the remaining deflection rollers 15, this deflection roller, which has been assigned reference numeral 15′ in FIGS. 9 and 10, is provided with teeth on the circumference thereof, which teeth comb with teeth of the rope 9 so as to transmit a driving force of the motor 31 to the traction rope 7. The method of operation of this embodiment is the same as that described with reference to FIGS. 7 and 8.

A further example for the use of the hinge device according to invention is illustrated in FIG. 11. It shows a schematic illustration of a front region of a motor vehicle 23 with an open engine hood 16.

The engine hood 16 is attached to the frame of the motor vehicle 23 with the hinge device 2 illustrated in FIGS. 1 and 2. Due to the hinge device 2, the engine hood 16 during opening pivots open in a parallel fashion and in the open state assumes the position shown according to FIG. 11, having the same orientation as in the closed state. The same is possible for a trunk hood of the motor vehicle 23.

Instead of having the toothed belts 7 mesh with the top parts 4, 5 via disks 10, 11 non-rotatably connected thereto, as is shown according to FIGS. 1 to 4, the top parts 4, 5 can be coupled to the disks 10, 11 via gear sets, which is shown in the enlarged illustration of an end region of the lever 6 according to FIG. 12. A gear wheel 19, which is firmly connected to the disk 10, is provided coaxially to the disk 10 and meshes with a gear wheel 20 that is firmly connected to the top part 4. The gear wheels 19, 20 acts as a gear set, which transmits torque from the disk 10 to the top part 4. The gear set has a gear ratio of greater than 1, meaning the disk 10 rotates faster than the top part 4. In this embodiment, the toothed belt 7 therefore revolves more quickly on the inside of the lever 6 than in the levers according to FIGS. 1 to 4. The force transmitted by the toothed belt 7 is consequently reduced, so that a desired mechanical load-bearing capacity of the lever 6 can already be achieved with low strength of the housing.

If the gear ratios of the gear sets are the same on both ends of the lever, the door or hood attached to the top part 4 pivots open in a parallel fashion.

As an alternative to the embodiment according to FIG. 12, the disk 10 may also be coupled to the top part 4 by means of a planetary gear set 24, which is shown in a lateral sectional view according to FIG. 13. The disk 10 is non-rotatably connected to a sun gear ring gear [sic] 25 of the planetary gear set 24. A ring gear 27 is firmly connected to the housing of the lever 6. Planetary gears 26 mesh with the ring gear 27 and sun gar 25 and are supported by a planet carrier that is locked to the top part 4. When the top part 4 pivots relative to the lever 6, the planetary gears revolve on their track and thus cause a rotation of the sun gear 25.

Another example is illustrated in FIG. 14, which shows a sectional view through part of a motor vehicle with a fold-up swing door 21, which is attached to a frame of the motor vehicle in an upper region using a hinge device 22 according to the invention. The axes of rotation of the hinge device are horizontal, so that they guide the door 21 in a substantially vertical movement. FIG. 14 shows the door 21 in a closed state. The hinge device 22 comprises a long curved lever 6. Owing to the length of the lever 6, the door 21 pivots open far enough to allow the motor vehicle to be entered, which is shown in FIG. 15.

### LIST OF REFERENCE NUMERALS

1. Door

2. Hinge Device

3. Side Wall

4. Top Part

5. Top Part

6. Lever

7. Toothed Belt

8. Traction Rope

9. Traction Rope

10. Disk

11. Disk

12. Gripping Point

13. Gripping Point

14. Projection

15. Deflection Roller

16. Gripping Point

17. Gripping Point

18. Engine Hood

19. Gear Wheel

20. Gear Wheel

21. Swing Door

22. Hinge Device

23. Motor Vehicle

24. Planetary Gear Arrangement

25. Sun Gear

26. Planetary Gear

27. Ring Gear

28. Interior Molding

29. Groove

30. B-Column

31. Electric Motor

32. Pinion

33. Intermediate Pinion

34. Switch

35. Switch

1. A hinge device (2, 22) comprising a lever (6) that is provided with two top parts (4, 5), which are used for assembling the lever (6) and are pivotable about a pin, characterized by two bodies (10, 11), of which each can pivot about an axis of rotation coupled with the pivoting movement of an associated top part (4, 5), and comprising two traction ropes (8, 9), which grip the two bodies (10, 11) on gripping points (12, 13, 16, 17) on different sides of a plane in which the two axes of rotation are located.

2. The hinge device (2, 22) according to claim 1, characterized in that the bodies (10, 11, 27) are rotatably coupled to the respectively associated top part (4, 5) at equivalent gear ratios and that the gripping points (12, 13, 16, 17) have the same distance from the plane.

3. The hinge device (2, 22) according to claim 1 or 2, characterized in that the connected traction ropes (8, 9) are wrapped around at least one of the bodies (10, 11).

4. The hinge device (2, 22) according to claim 3, characterized in that a wrapped surface of the body (10, 11 ) has a substantially circular or circular sector shape.

5. The hinge device (2, 22) according to claim 4, characterized in that the body (10, 11) is a gear wheel.

6. A hinge device (2, 22) according to any one of the preceding claims, characterized in that the pin of the top part (4, 5) coincides with the axis of rotation of the respectively associated body (10, 11).

7. A hinge device (2, 22) according to any one of the preceding claims, characterized in that the traction ropes (8, 9) are continuously connected into an endless loop (7).

8. A hinge device (2) according to any one of the preceding claims, characterized in that the body (10, 1 1) is rigidly connected to the associated top part (4, 5).

9. A hinge device (2, 22) according to any one of the claims 1 to 7, characterized in that the body (10, 11) is connected to the associated top part (4, 5) via a gear set (19, 20; 24).

10. The hinge device (2, 22) according to claim 9, characterized in that the gear set is a planetary gear arrangement (24).

11. A hinge device (2, 22) according to any one of the preceding claims, characterized in that the traction ropes (8, 9) are chains.

12. A hinge device (2, 22) according to any one of the claims 1 to 11, characterized in that the traction ropes (8, 9) are belts.

13. A hinge device (2, 22) according to any one of the preceding claims, characterized in that the lever (6) is bent in at least one angle.

14. The hinge device (2, 22) according to claim 13, characterized by deflection elements (15) for the traction ropes (8, 9), which elements are disposed on the angle.

15. The hinge device (2, 22) according to claim 14, characterized in that the deflection elements (15) are rollers.

16. The hinge device (2, 22) according to claim 14 or 15, characterized in that the angle divides the lever into two sections with different lengths and that the traction ropes (8, 9) extend toward each other from the top part (4) to the angle on the one of the two sections to which the door (1) is connected.

17. The hinge device (2, 22) according to claim 14 or 15, characterized in that the outer traction rope (9) extending on a convex side of the lever (6) is guided via two deflection elements (15).

18. A hinge device (2, 22) according to any one of the preceding claims, characterized in that the lever (6) is hollow and the traction ropes (8, 9) and the bodies (10, 11) are accommodated therein.

19. A hinge device according to any one of the preceding claims, characterized in that a motor for driving a pivoting movement of the top parts in relation to the lever (6) is attached to the lever (6).

20. The hinge device according to claim 19, characterized in that the motor carries a pinion meshing with one of the traction ropes (8, 9).

21. The hinge devices according to claim 19 and claim 5, characterized in that the motor carries a pinion meshing with one of the gear wheels (10, 11).

22. The hinge devices according to claim 18 and any one of the claims 19 to 21, characterized in that the motor is accommodated in the hollow lever (6).

23. A combined hinge device, characterized by a shaft, to which a plurality of hinge devices (2, 22) according to any one of the preceding claims are connected.

24. A door (1, 21) comprising hinge devices (2, 22) according to any one of the claims 1 to 18 or the combined hinge device according to claim 19, wherein the levers (6) are mounted on the door (1, 21) with a first one of the top parts (4, 5) and are disposed staggered in such a manner that the first and second axes coincide.

25. A motor vehicle (23) comprising the door (1, 21) according to claim 20, wherein the levers (6) are mounted on a frame of the motor vehicle (23) using a second of the top parts (4, 5).

26. The motor vehicle according to claim 21, characterized by a horizontal orientation of the axes of rotation.

27. The motor vehicle according to claim 21, characterized by a vertical orientation of the axes of rotation.

28. A motor vehicle (23) comprising an engine hood (18) with at least one hinge device (2, 22) according to any one of the claims 1 to 18 or a combined hinge device according to claim 19.

29. A motor vehicle (23) comprising a tailgate with at least one hinge device (2, 22) according to any one of the claims 1 to 18 or a combined hinge device according to claim 19.
